(19) United States
(12) Patent Application Publication
(10) Pub. No.: US 2026/0212573 A1
(43) Pub. Date: Jul. 23, 2026

(54) HYBRID IMITATION LEARNING FOR NEURAL MOTION CONTROL

(71) Applicant: NVIDIA Corporation, Santa Clara, CA (US)

(72) Inventors: Xue Bin PENG, Vancouver (CA); Jiashun WANG, Santa Clara, CA (US); Sanja FIDLER, Toronto (CA); Davis Winston REMPE, Redwood City, CA (US); Chen TESSLER, Zichron Yaakov (IL); Haotian ZHANG, Santa Clara, CA (US); Yifeng JIANG, Santa Clara, CA (US)

(21) Appl. No.: 19/034,460

(22) Filed: Jan. 22, 2025

(51) Int. Cl. G06T 13/00; G06N 3/092

(52) U.S. Cl. CPC G06T 13/00; G06N 3/092

(57) ABSTRACT

In various examples, a technique for hybrid imitation learning includes generating, via execution of a first machine learning model, a first plurality of actions based on a first plurality of states associated with a virtual character and computing a first set of rewards based on the first plurality of actions and a reference motion for the virtual character. The technique also includes generating, via execution of the first machine learning model, a second plurality of actions based on a second plurality of states associated with the virtual character and a training target goal and computing a second set of rewards based on discriminator output generated by a second machine learning model from the second plurality of actions. The technique further includes updating one or more parameters of the first machine learning model based on the first and second sets of rewards to produce a trained machine learning model.

### TECHNICAL FIELD

Embodiments of the present disclosure relate generally to machine learning and motion control, and more specifically to hybrid imitation learning for neural motion control.

### BACKGROUND

Neural motion control refers to the use of a neural network (or another type of machine learning model) to animate virtual characters-ideally, in real-time or near real-time. For example, a deep learning model may be trained to perform motion control by generating a sequence of poses (i.e., positions and orientations) corresponding to a physical simulation of motion in a virtual character (e.g., a human, animal, robot, etc.). The outputted poses may then be incorporated into a game, an animation, a robot or other autonomous machine, a simulation, and/or another application involving the virtual character.

However, it can be difficult for a neural motion control model to learn simulated motions that are both realistic and generalizable. More specifically, conventional techniques for training neural motion control models are typically grouped under motion tracking techniques or distribution matching techniques. A motion tracking technique involves using a tracking objective to train a machine learning model to replicate a reference motion, which may include (but is not limited to) a real-world human (or another type of character) performing the reference motion. While a machine learning model that is trained using the motion tracking technique is capable of replicating a wide range of specifically- and individually-modeled motor skills, the machine learning model is generally unable to adapt to new environments and can have difficulty with sequencing and composing different motor skills.

On the other hand, a distribution matching technique involves training a machine learning model to generate motions that resemble a set of reference motions instead of requiring the generated motions to closely replicate the reference motion. While a machine learning model that is trained using the distribution matching technique has the flexibility to modify and adapt motor skills to new environments, motions generated by the machine learning model may deviate from the reference motions, thereby resulting in less natural and/or realistic behaviors. Further, the performance of the distribution matching technique typically decreases as the complexity of the environment increases.

As the foregoing illustrates, what is needed in the art are more effective techniques for generating physically simulated motions in virtual characters.

### BRIEF DESCRIPTION OF DRAWINGS

FIG. 1 illustrates a block diagram of a computing system configured to implement one or more aspects of at least one embodiment;

FIG. 2 is a more detailed illustration of the training engine and execution engine of FIG. 1, according to at least one embodiment;

FIG. 3A illustrates an example architecture for the trained policy of FIG. 2, according to at least one embodiment;

FIG. 3B illustrates an example architecture for the discriminator of FIG. 2, according to at least one embodiment;

FIG. 3C illustrates an example architecture for the critic of FIG. 2, according to at least one embodiment;

FIG. 4 illustrates a set of example motions generated by the trained policy of FIG. 2, according to at least one embodiment;

FIG. 5 illustrates a set of example motions generated by the trained policy of FIG. 2, according to at least one embodiment;

FIG. 6 illustrates a flow diagram of a method for training a machine learning model under a hybrid imitation learning framework for neural motion control, according to at least one embodiment;

FIG. 7A illustrates inference and/or training logic, according to at least one embodiment;

FIG. 7B illustrates inference and/or training logic, according to at least one embodiment; and

FIG. 8 illustrates training and deployment of a neural network, according to at least one embodiment.

### DETAILED DESCRIPTION

As discussed herein, it can be difficult for a neural motion control model to learn simulated motions that are both realistic and generalizable. More specifically, existing motion tracking techniques are capable of replicating a wide range of motor skills but can exhibit suboptimal performance in adapting to new environments and/or sequencing and composing different motor skills. At the same time, distribution matching techniques can modify and adapt motor skills to new environments but can also generate motions that deviate from reference motions and/or appear unnatural and/or unrealistic, particularly as the complexity of the environment increases.

To address the above limitations, the disclosed techniques use a hybrid imitation learning framework to train a machine learning model to generate motions for a virtual character in a variety of complex environments. For example, the hybrid imitation learning framework may be used to generate a trained machine learning model that is capable of performing and rapidly transitioning between a variety of motor skills in environments involving different types and/or combinations of obstacles.

The hybrid imitation learning framework involves a multi-task environment that includes a tracking task and a target following task. In the tracking task, the machine learning model is optimized to track a reference motion on a frame-by-frame basis. For example, the tracking task may involve training the machine learning model to perform a variety of motor skills by imitating reference motions recorded from humans. The tracking task may use a motion tracking reward that encourages the machine learning model to minimize the difference between positions, rotations, linear velocities, angular velocities, root heights, and/or other attributes of the virtual character and corresponding ground truth attributes associated with a given reference motion.

In the target following task, the machine learning model is trained to learn natural interactions with an environment while following a target goal. For example, the target following task may involve sampling a target goal location within an environment that includes various objects and/or obstacles with which the virtual character can interact. The machine learning model may be trained using a task objective that includes a reward that increases as the distance between the virtual character and the target goal location reduces. The machine learning may also be trained using a style objective that is computed using predictions from a discriminator model that aims to distinguish between reference motions and motions outputted by the neural motion control model.

After training of the machine learning model is complete, the machine learning model is used to generate motions for the virtual character in new environments. For example, the machine learning model may generate motions that allow the virtual character to interact with various objects and/or obstacles using learned motor skills and/or smoothly transition between motor skills while moving toward a target goal location within a new environment.

One advantage of the disclosed techniques relative to prior approaches is the ability to generate natural and realistic motions for virtual characters in unseen and/or complex environments. Consequently, a machine learning model trained, retrained, or updated using the disclosed techniques may exhibit improved generalizability and ability to sequence and/or compose different motor skills compared with machine learning models trained using conventional motion tracking techniques. Further, the generated motions may be more realistic and/or natural than those generated via machine learning models trained using conventional distribution matching techniques.

The above examples are not in any way intended to be limiting. As persons skilled in the art will appreciate, as a general matter, the techniques for automatically generating dialogue flows from unlabeled conversation data can be implemented in any suitable application.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as large language models (LLMs), small language models (SLMs), vision language models (VLMs), and/or multi-modal language models that may process text, audio, and/or image data, systems for performing light transport simulation, systems for performing collaborative content creation for 3D assets (e.g., systems or platforms that use universal scene descriptor (USD) data, such as OpenUSD), systems implemented at least partially using cloud computing resources, systems for performing generative AI operations, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### System Overview

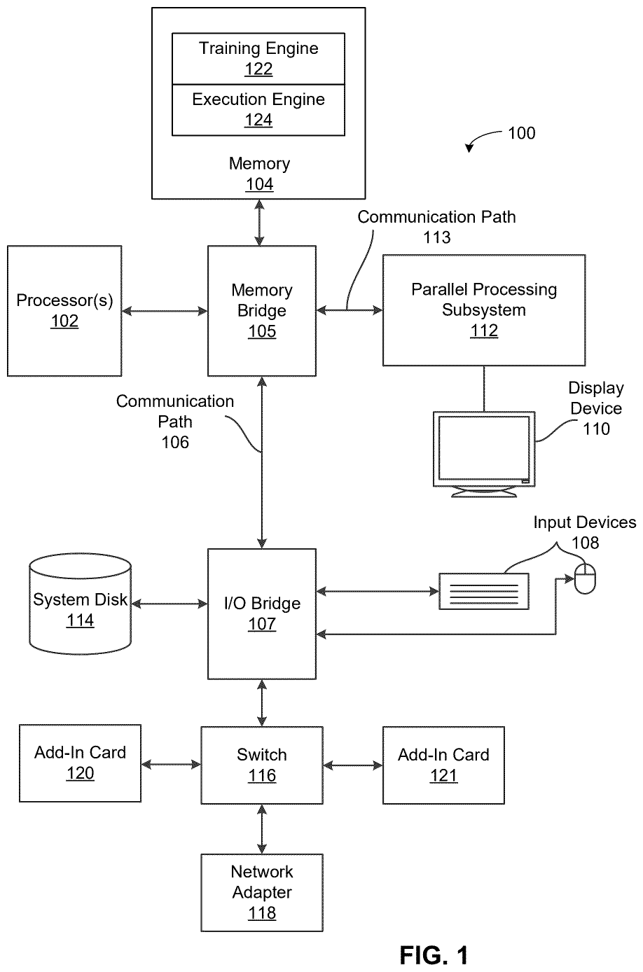

FIG. 1 is a block diagram illustrating a computing system 100 configured to implement one or more aspects of at least one embodiment. In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include instructions implementing a training engine 122 and an execution engine 124, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs, pixel processing engines (PPEs), and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a Peripheral Component Interconnect Express (PCIe) link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor (ies) 104 may be connected to processor(s) 102 directly rather than through memory bridge 105, and other devices may communicate with memor (ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add-in cards 120, 121 would connect directly to I/O bridge 107. Further, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

In some embodiments, training engine 122 and execution engine 124 include functionality to train and execute a machine learning model under a hybrid imitation learning framework for neural motion control. More specifically, training engine 122 trains the machine learning model in a multi-task environment that includes a tracking task and a target following task. In the tracking task, the machine learning model is optimized to track a reference motion on a frame-by-frame basis. In the target following task, the machine learning model is trained to follow a target goal across different sequences of obstacles. After training of the neural motion control model is complete, execution engine 124 uses the machine learning model to generate motions for the virtual character in new environments. Training engine 122 and execution engine 124 are described in further detail below.

### Hybrid Imitation Learning Framework for Neural Motion Control

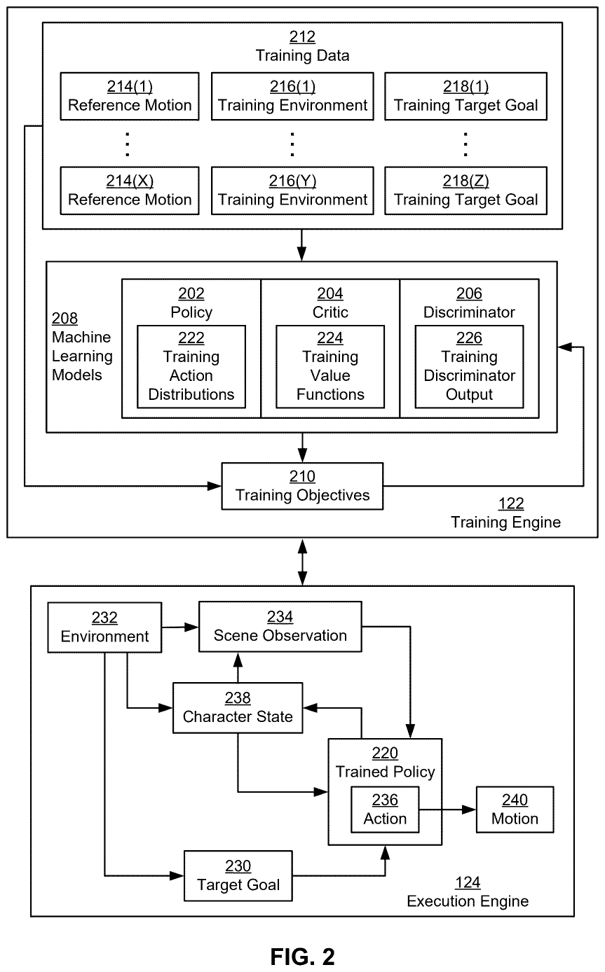

FIG. 2 is a more detailed illustration of training engine 122 and execution engine 124 of FIG. 1, according to at least one embodiment. As discussed herein, training engine 122 and execution engine 124 are configured to train (update) and execute a set of machine learning models 208 to under a hybrid imitation learning framework for neural motion control. Each of these components is described in further detail below.

In one or more embodiments, neural motion control includes iteratively executing a trained policy 220 included in machine learning models 208 to generate a different action 236 for each frame, or time step, in a motion 240 for a virtual character. For example, trained policy 220 may be used to generate a certain motion 240 for a human, animal, robot, and/or another type of articulated object corresponding to the virtual character. Each action 236 outputted by trained policy 220 may be used to update a configuration of joints and/or other parts of the virtual character at a corresponding time step, thereby resulting in a corresponding motion 240 in the virtual character. A sequence of actions generated by trained policy 220 for a corresponding sequence of time steps may be used to replicate a complex motor skill such as (for example and without limitation): running, jumping, spinning, crawling, tumbling, dancing, kicking, punching, ducking, flipping, climbing, spinning, vaulting, leaping, and/or rolling.

As shown in FIG. 2, each action 236 is generated by trained policy 220 based on an environment 232, a scene observation 234, a character state 238, and a target goal 230. Environment 232 includes a three-dimensional (3D) representation of terrain, objects, obstacles, structures, and/or other components with which the virtual character can interact during the generation of motion 240. For example, environment 232 may include a point cloud, mesh, universal scene description (USD), and/or another 3D representation of an obstacle course to be cleared and/or navigated by the virtual character. The obstacle course may include a ground with a certain topography (e.g., flat, sloping, uneven, stepped, etc.). The obstacle course may also include objects, shapes, and/or other types of obstacles in various positions and/or orientations in environment 232.

Target goal 230 includes an intent associated with a given action 236 and/or motion 240. For example, target goal 230 may include a location within environment 232 to which the virtual character is to navigate, a type of motion 240 to be performed by the virtual character, and/or another type of result to be achieved by a given action 236 and/or motion 240. Target goal 230 may be randomly generated, specified by a user, and/or otherwise determined. After target goal 230 is reached by the virtual character, a new target goal 230 may optionally be generated within the same environment 232 to extend the generation of motion 240 for the virtual character.

Character state 238 includes a configuration of joints and/or other parts in the virtual character at a given time step. For example, character state 238 may be represented by sₜ=(hₜ, pₜ, qₜ, \acute{p}ₜ, \acute{q}ₜ), where t is a time step, hₜ is the height of a root (e.g., the pelvis) in the virtual character from the ground at that time step, pₜ represents per-joint positions at that time step in a local coordinate frame, qₜ represents per-joint rotations at that time step in the local coordinate frame, \acute{p}ₜ represents per-joint linear velocities at that time step in the local coordinate frame, and qₜ represents per-joint angular velocities at that time step in the local coordinate frame. The local coordinate frame may be defined with the origin located at the root, the x-axis oriented along the facing direction of the root link, and the z-axis aligned with a global up vector.

Scene observation 234 includes a representation of environment 232 that is generated based on character state 238. Continuing with the above example, surfaces in environment 232 may be represented by a point cloud, mesh, parameterized shapes, and/or other types of 3D data. Scene observation 234 may be denoted by cₜ and include N points that are closest to the virtual character at time step t.

Given input that includes scene observation 234, character state 238, and target goal 230 for a certain time step, trained policy 220 generates a corresponding action 236. For example, trained policy 220 may use the input to generate parameters of an action distribution for the time step. A corresponding action 236 may be sampled from the action distribution and used to update character state 238 for the next time step. The process may then be repeated to generate a new action 236 for the next time step until target goal 230 is reached and/or another condition is met.

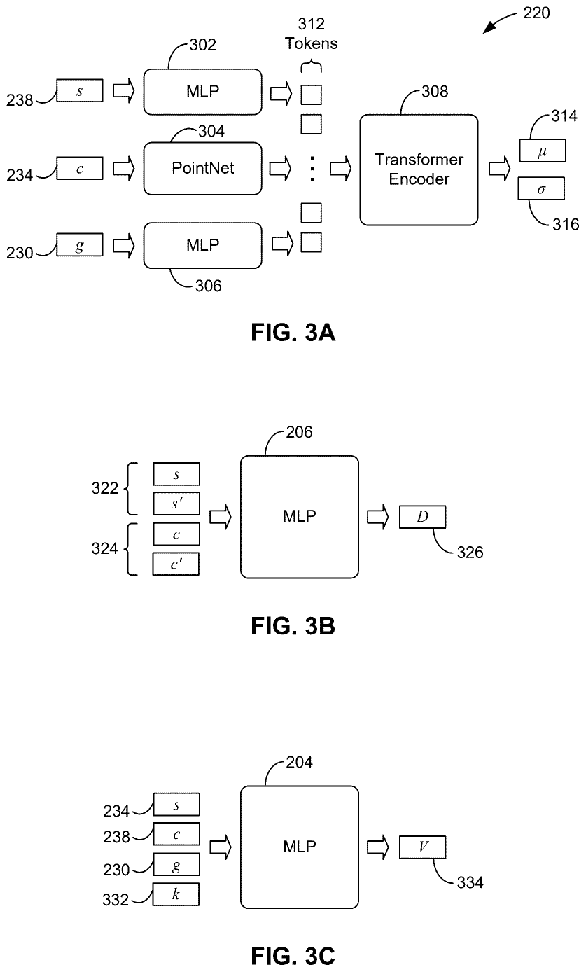

FIG. 3A illustrates an example architecture for trained policy 220 of FIG. 2, according to at least one embodiment. As shown in FIG. 3A, trained policy 220 includes a first multilayer perceptron (MLP) 302, a PointNet 304 neural network, a second MLP 306, and a transformer encoder 308.

MLP 302 encodes character state 238 (as denoted by s in FIG. 3A) as a first set of one or more tokens 312. PointNet 304 extracts features from a set of points in scene observation 234 (as denoted by c in FIG. 3A) and encodes the extracted features as a second set of one or more tokens 312. MLP 306 encodes target goal 230 (as denoted by gin FIG. 3A) as a third set of one or more tokens 312.

All three sets of tokens 312 are inputted into transformer encoder 308. Transformer encoder 308 uses a set of attention blocks and/or attention mechanisms to compute attention scores that iteratively “transform” tokens 312 into corresponding output tokens. Tokens outputted by the last transformer block in transformer encoder 308 may be processed by one or more neural network layers to generate a mean 314 (as denoted by u in FIG. 3A) and a standard deviation 316 (as denoted by σ in FIG. 3A) of a Gaussian action distribution. Consequently, the example architecture of FIG. 3A may allow trained policy 220 to integrate multi-modal observations and adapt actions to novel and complex environments.

For example, the operation of trained policy 220 may be represented by:

$$π ( a \vert s , c , g ) = 𝒩 ( {μ}_{π} ( a \vert s , c , g ) , {\sum }_{π} ) \qquad ( 1 )$$

In the above equation, π denotes trained policy 220, μ_{π} is mean 314 of a multidimensional Gaussian action distribution, and Σ_{π} is a constant diagonal covariance matrix with values o_{π}=0.055.

Returning to the discussion of FIG. 2, training engine 122 generates trained policy 220 by training machine learning models 208 that include a corresponding policy 202, a critic 204, and a discriminator 206. In some embodiments, training engine 122 trains machine learning models 208 using a set of training data 212 and a set of training objectives 210.

Training data 212 includes a set of reference motions 214(1)-214(X) (each of which is referred to individually herein as reference motion 214), a set of training environments 216(1)-216(Y) (each of which is referred to individually herein as training environment 216), and a set of training target goals 218(1)-218(Z) (each of which is referred to individually herein as training target goal 218). Reference motions 214 include “ground truth” motions to be learned by one or more machine learning models 208. For example, each reference motion 214 may include a sequence of ground truth character states that depict movement in the virtual character. Each character state in the sequence may be associated with a different “frame,” or time step, in the corresponding reference motion 214. As with character state 238, each ground truth character state may include a root height, joint positions, joint orientations, joint velocities, and/or other features that describe the configuration of the virtual character at a corresponding time step.

Like environment 232, each training environment 216 includes representations of terrain, objects, obstacles, structures, and/or other components with which the virtual character can interact. For example, a given training environment 216 may include an obstacle course to be cleared and/or navigated by the virtual character. The obstacle course may include a ground with a certain topography and/or an arrangement of objects, shapes, and/or other types of obstacles.

Each training target goal 218 includes an intent associated with a given reference motion 214 and/or training environment 216. For example, a given training target goal 218 may include a location within a corresponding training environment 216 to which the virtual character is to navigate, a type of motion to be performed by the virtual character, and/or another type of result to be achieved via motion in the virtual character.

In some embodiments, training engine 122 uses reinforcement learning (RL) to train an agent that uses policy 202 to interact with a given training environment 216. At each time step t, the agent observes the current character state 238 sₜ and samples a corresponding action 236 aₜ using policy 202 π(aₜ | sₜ). Upon executing that action 236, the virtual character transitions to a new character state 238 sₜ₊₁, following the dynamics sₜ₊₁~p(sₜ₊₁ | sₜ, aₜ), and the agent receives a reward rₜ=r(sₜ, aₜ, sₜ₊₁). RL training objectives 210 include learning a corresponding trained policy 220 π that maximizes the expected discounted return J(π), which is defined as:

$$J ( π ) = {𝔼}_{p ( τ \vert π )} [ {\sum }_{t = 0}^{T - 1} {γ}^{t} {r}_{t} ] \qquad ( 2 )$$

The probability of a trajectory τ={s₀, a₀, r₀, s₁, . . . , s_{T-1}, a_{T-1}, r_{T-1}, s_{T}} is expressed as

$$p ( τ \vert π ) = p ( {s}_{0} ) {\prod }_{t = 0}^{T - I} p ( {s}_{t + 1} \vert {s}_{t} , {a}_{t} ) π ( {a}_{t} \vert {s}_{t} )$$

under the policy π. Here, p(s₀) is the initial state distribution, T represents the time horizon of a trajectory, and γ∈[0,1] is a discount factor.

Training engine 122 additionally trains machine learning models 208 within a multi-task environment that includes a tracking task and a target following task. In the tracking task, training engine 122 trains policy 202 to track reference motions 214 in training data 212. In the target following task, training engine 122 trains policy 202 to learn natural interactions with obstacle, objects, and/or other entities in a given training environment 216 while following a randomly selected training target goal 218 within that training environment 216. By training policy 202 on an equal distribution (or a different distribution) of both tasks, training engine 122 may generate a corresponding trained policy 220 that can produce complex motor skills and adaptively respond to new obstacles and/or environments.

In one or more embodiments, policy 202 includes the same architecture as trained policy 220 and parameters that are initialized and/or pretrained using a warm start tracking policy (e.g., a policy that has been trained to perform the tracking task). Training engine 122 may then use the hybrid imitation learning framework to train policy 202 on both the tracking task and target following task.

Training engine 122 further generates and/or uses different types and/or subsets of training data 212 to train machine learning models 208 on the tracking task and target following task. More specifically, training on the tracking task involves the use of reference motions 214 and corresponding training environments 216 in training data 212. For example, reference motions 214 may include real-world motions by humans (or other types of articulated objects). Training environments 216 associated with these reference motions 214 may include representations of obstacles with which the humans interact during the real-world motions. Reference motions 214 may be generated using motion capture techniques, vision-based pose estimation techniques applied to videos of the real-world motions, and/or other techniques and/or data associated with the real-world motions. After a given reference motion 214 is generated from a real-world motion, a simulation environment (e.g., NVIDIA Isaac Sim™, NVIDIA Isaac Gym™, and/or NVIDIA Drive Sim™, which are registered trademarks of NVIDIA Corporation) may be used to (re) play a loop of that reference motion 214 within a corresponding training environment 216, and human annotation may be used to place geometries corresponding to obstacles encountered during the real-world motion in the corresponding training environment 216. Further, physics-based motion tracking may be used to reduce noise and/or improve physical correctness and/or naturalness in that reference motion 214.

During the tracking task, training engine 122 inputs character states sₜ and scene observations cₜ associated with one or more reference motions 214 and corresponding training environments 216 into policy 202. Training engine 122 uses policy 202 to generate corresponding training action distributions 222 and samples actions at from training action distributions 222. Training engine 122 also trains policy 202 using a motion tracking training objective, which encourages the virtual character to minimize the difference between the state of the simulated character and each reference motion 214 at each timestep t:

$${r}_{t}^{track} = {w}_{p} {e}^{- {α}_{p} ‖ {\hat{p}}_{t} - {p}_{t} ‖} + {w}_{r} {e}^{- {α}_{r} ‖ {\hat{q}}_{t} ⊖ {q}_{t} ‖} + {w}_{\dot{p}} {e}^{- {α}_{\dot{p}} ‖ {\hat{p}}_{t} - {\hat{p}}_{t} ‖} + {w}_{\dot{q}} {e}^{- {α}_{\dot{q}} ‖ {\hat{\dot{q}}}_{t} - {\dot{q}}_{t} ‖} + {w}_{h} {e}^{- {α}_{h} ‖ {\hat{h}}_{t} - {h}_{t} ‖} + {w}_{eg} {\sum }_{j} ‖ {τ}_{j} {\dot{q}}_{j} ‖ \qquad ( 3 )$$

In the above equation, w_{{·}} and a_{{·}} are weights used to balance different reward terms in the motion tracking reward

$${r}_{t}^{track} .$$

The motion tracking objective thus encourages the character to imitate the position \acute{p}, rotation \acute{q}, linear velocity \acute{p} and angular velocity \acute{q} and the root height \acute{h} specified by a given reference motion 214. The motion tracking objective also includes an energy penalty w_{eg} Σⱼ ∥τⱼ\acute{q}ⱼ∥ that encourages smoothness and mitigates jittering in generated motions.

On the other hand, training of machine learning models 208 on the target following task may be performed in the absence of reference motions 214. Instead, training data 212 used in the target following task may include training environments 216 that differ from those associated with reference motions 214 and training target goals 218 associated with these training environments 216. For example, a given training environment 216 associated with the target following task may be generated via random placement of obstacles within a corresponding 3D space; scanning of a real-world environment; moving, rotating, arranging, and/or otherwise placing obstacles from one or more other training environments 216; human input; procedural generation techniques; and/or other techniques. One or more training target goals 218 may be sampled (e.g., to be near one or more obstacles), specified via human input, and/or otherwise generated for each training environment 216 associated with the target following task.

During the target following task, training engine 122 trains policy 202 on training objectives 210—including a task objective and a style objective—that collectively represent an adversarial distribution matching imitation objective. The task objective guides the character along a given obstacle course and/or within a given training environment 216, while the style objective aims to produce natural and/or realistic motions in the virtual character that resemble reference motions 214.

In some embodiments, the task objective encourages the virtual character to traverse a sequence of obstacles within a given training environment 216 by moving toward a location corresponding to a given training target goal 218. Once the virtual character reaches a current training target goal 218, a new training target goal 218 (e.g., near a different obstacle) can be sampled. For example, the task objective may include the following representation:

$${r}_{t}^{target} = ‖ {p}_{t - 1}^{root} - {g}_{t - 1} ‖ - ‖ {p}_{t}^{root} - {g}_{t} ‖ + {r}_{t}^{reach} \qquad ( 4 )$$

In the above equation, p^{root} is the position of the root in the virtual character, and gₜ is a given training target goal 218. The reward

$${r}_{t}^{target}$$

associated with task objective thus encourages policy 202 to continually reduce the distance between the virtual character and the location corresponding to training target goal 218, with an additional one-time success bonus rₜ^{reach} awarded upon reaching the location.

In one or more embodiments, the style objective is generated using output (e.g., training discriminator output 226) from discriminator 206. For example, discriminator 206 may be trained in an alternating fashion with policy 202 to distinguish between data associated with training action distributions 222 outputted by policy 202 as real reference motions 214 or “fake” motions produced by policy 202. Training discriminator output 226 generated by discriminator 206 from the character states and scene observations may indicate whether a given set of inputted data is derived from reference motions 214 or produced by policy 202. Discriminator 206 is described in further detail below with respect to FIG. 3B.

FIG. 3B illustrates an example architecture for discriminator 206 of FIG. 2, according to at least one embodiment. As shown in FIG. 3B, input into discriminator 206 includes a number of state transitions 322 (e.g., as denoted by s, s′) between character states for consecutive time steps, as well as a number of scene transitions 324 (e.g., as denoted by c, c′) between consecutive scene observations for the same time steps. For example, state transitions 322 and scene transitions 324 may include a certain number of consecutive character states and scene observations, respectively, that were produced as a result of the same number of corresponding actions generated by policy 202. Discriminator 206 may thus be denoted by D(s, s′, c, c′), where (s, s′) and (c, c′) denote a sequence of character states and scene observations, respectively, across that number of consecutive time steps.

In the example of FIG. 3B, discriminator 206 includes an MLP that converts the inputted state transitions 322 and scene transitions 324 into training discriminator output 326 (as denoted by D in FIG. 3B). For example, discriminator 206 may generate, as training discriminator output 326, a score between 0 and 1 that represents the probability that the inputted state transitions 322 and scene transitions 324 are fake. The inclusion of scene transitions 324 across scene observations in input to discriminator 206 may allow discriminator 206 to determine not only whether a motion is natural or not, but also whether the motion fits the current scene.

In one or more embodiments, discriminator 206 is trained using a binary classification objective that includes a gradient penalty to penalize nonzero gradients on samples from reference motions 214:

$${min}_{D} - {𝔼}_{{d}_{M} ( s , {s}^{′} , c , {c}^{′} )} log ( D ( s , {s}^{′} , c , {c}^{′} ) ) - {𝔼}_{{d}_{π} ( s , {s}^{′} , c , {c}^{′} )} log ( 1 - D ( s , {s}^{′} , c , {c}^{′} ) ) + {w}_{gp} {𝔼}_{{d}_{M} ( s , {s}^{′} , c , {c}^{′} )} {‖ {∇}_{ϕ} D ( ϕ ) {\vert}_{ϕ = ( s , {s}^{′} , c , {c}^{′} )} ‖}^{2} \qquad ( 5 )$$

where w_{gp} is a manually specified weight associated with the gradient penalty.

The style objective used to train policy 202 may include the following representation:

$${r}^{style} = - log ( 1 - D ( s , {s}^{′} , c , {c}^{′} ) ) \qquad ( 6 )$$

The style objective thus encourages policy 202 to produce more natural motions while also utilizing appropriate skills for interacting with particular training environments 216.

A combined reward for the target following task is computed as a weighted combination of the style and task training objectives 210:

$${r}^{task} = {w}^{target} {r}^{target} + {w}^{style} {r}^{style} \qquad ( 7 )$$

In the above equation, w^{target} and w^{style} represent weights for the task objective and style objective, respectively. The combined reward thus provides the virtual character with more flexibility to adapt and compose skills from the motion dataset to clear new obstacles and scenes.

Returning to the discussion of FIG. 2, in some embodiments, training engine 122 further uses training value functions 224 outputted by critic 204 to train policy 202. For example, training engine 122 may input representations and/or results of actions generated via policy 202, a binary task indicator that identifies the current task associated with the actions (e.g., tracking, target following, etc.), and/or other data associated with the generated actions into critic 204. Training engine 122 may use critic 204 to generate, using the inputted data, training value functions 224 that represent expected returns associated with the corresponding policy 202. Training engine 122 may also use values computed using training value functions 224 to optimize policy 202. Critic 204 is described in further detail below with respect to FIG. 3C.

FIG. 3C illustrates an example architecture for critic 204 of FIG. 2, according to at least one embodiment. As shown in FIG. 3C, the example architecture for critic 204 includes an MLP. Input into critic 204 includes a given scene observation 234, character state 238, and target goal 230 (e.g., when policy 202 is being trained on the target following task). Input into critic 204 also includes a task indicator 332 (e.g., as denoted by k), which identifies the type of task associated with scene observation 234, character state 238, and target goal 230. For example, task indicator 332 may include a binary value that specifies the type of task as tracking or target following.

Critic 204 uses the inputted data to generate a corresponding value 334 (e.g., as denoted by V), which is used by training engine 122 to train policy 202. For example, value 334 may represent the expected return associated with the inputted scene observation 234, character state 238, target goal 230, and task indicator 332. This expected return may be used to compute an advantage associated with an action sampled using policy 202. The computed advantage may then be used to update parameters of policy 202 in a way that increases subsequent expected rewards.

Returning to the discussion of FIG. 2, in some embodiments, training engine 122 trains policy 202, critic 204, and/or discriminator 206 by generating a given training environment 216 that includes a sequence of obstacles (e.g., by sampling the obstacles from other training environments 216 in training data 212). Each obstacle in the sequence may be associated with a corresponding reference motion 214 to be learned by policy 202. Training engine 122 may also generate a sequence of target training goals 218 as waypoints between adjacent obstacles, locations near obstacles, and/or at the end of the sequence of obstacles. Training engine 122 may also simulate interactions between the virtual character and the obstacles in that training environment 216 using a physics simulation environment (e.g., Isaac Gym) and generate corresponding scene observations, character states, and/or actions for each time step in the simulated interactions. Training engine 122 may additionally train policy 202, critic 204, and discriminator 206 using a task indicator for each time step, an optimization technique (e.g., Proximal Policy Optimization (PPO)), an advantage estimation technique (e.g., generalized advantage estimation (GAE)), and/or the techniques and training objectives 210 discussed above.

In one or more embodiments, training engine 122 initializes a starting character state 238 for each training environment 216 used to train machine learning models 208 by applying Gaussian noise to the initial character state sampled from a corresponding reference motion 214. This perturbed state initialization improves the robustness of policy 202 to a wider range of character states and the ability of policy 202 to transition between skills when interacting with sequences of obstacles.

Training engine 122 also, or instead, uses an early termination strategy to terminate a given training episode. For example, training engine 122 may terminate a training episode during the tracking task if any joint position deviates by more than a certain distance (e.g., 0.5 meters) from a corresponding reference motion 214. In another example, training engine 122 may terminate a training episode during the target following task if the virtual character falls down unintentionally or misses a training target goal by more than a certain distance (e.g., 2 meters. These early termination techniques may improve the sample efficiency associated with training machine learning models 208 and/or discourage policy 202 from learning undesirable behaviors.

After training of policy 202 on the tracking task and target following task is complete, execution engine 124 uses the resulting trained policy 220 to generate a new motion 240 for the virtual character based on a corresponding environment 232 and target goal 230. For example, execution engine 124 may generate an initial character state 238 and corresponding scene observation 234 using a default and/or starting position of the virtual character in environment 232. Execution engine 124 may also sample target goal 230 from environment 232, receive target goal 230 from a user, and/or otherwise determine target goal 230 as a location in environment 232. Execution engine 124 may input character state 238, scene observation 234, and target goal 230 into trained policy 220 and use trained policy 220 to generate a corresponding action 236. Execution engine 124 may add action 236 to the new motion 240 and use action 236 to generate an updated character state 238 and scene observation 234 for the next time step. Execution engine 124 may repeat the process for a certain number of time steps, until target goal 230 is reached, and/or another condition is met. After target goal 230 is reached, execution engine 124 may optionally generate a new target goal at a different location in environment 232 and continue using trained policy 220 to generate new actions that advance the virtual character toward the new target goal.

Execution engine 124 may additionally incorporate the generated motion 240 into various applications. For example, execution engine 124 may generate an animation of the virtual character performing motion 240 within a game, video, virtual world, visualization, and/or another setting. Execution engine 124 may also, or instead, generate commands that cause a robot to perform motion 240.

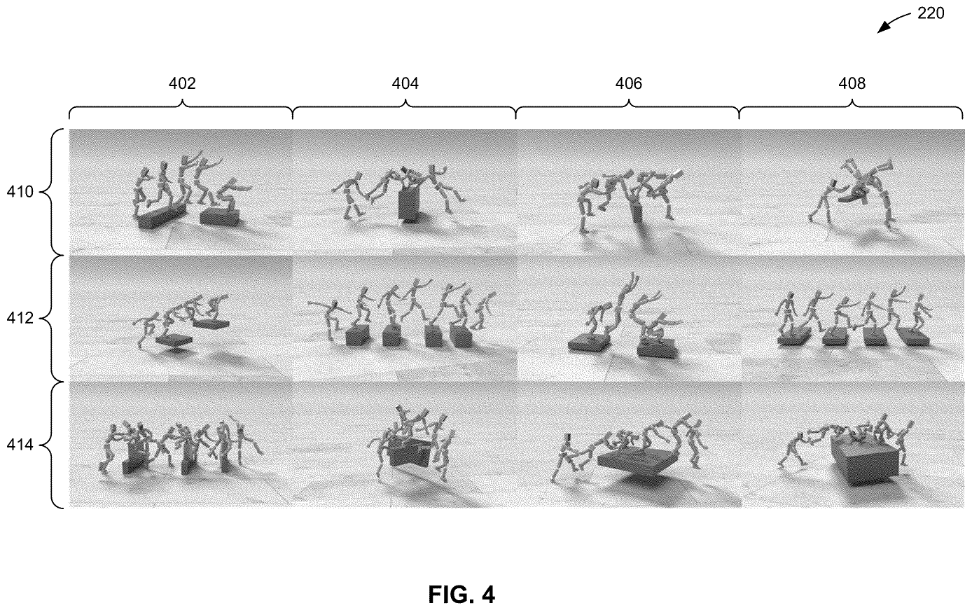

FIG. 4 illustrates a set of example motions generated by trained policy 220 of FIG. 2, according to at least one embodiment. As shown in FIG. 4, 12 example motions are arranged into three rows 410, 412, 414 and four columns 402, 404, 406, and 408. Each motion includes one or more motor skills learned by trained policy 220. For example, the example motions may include a wide range of motor skills, such as (but not limited to) jumping, vaulting, hurdling, somersaulting, stepping up, stepping down, jumping up, jumping down, hopping or running between steps, climbing, and/or rolling. Additionally, each motion may correspond to a natural and/or realistic interaction between the virtual character and one or more corresponding obstacles.

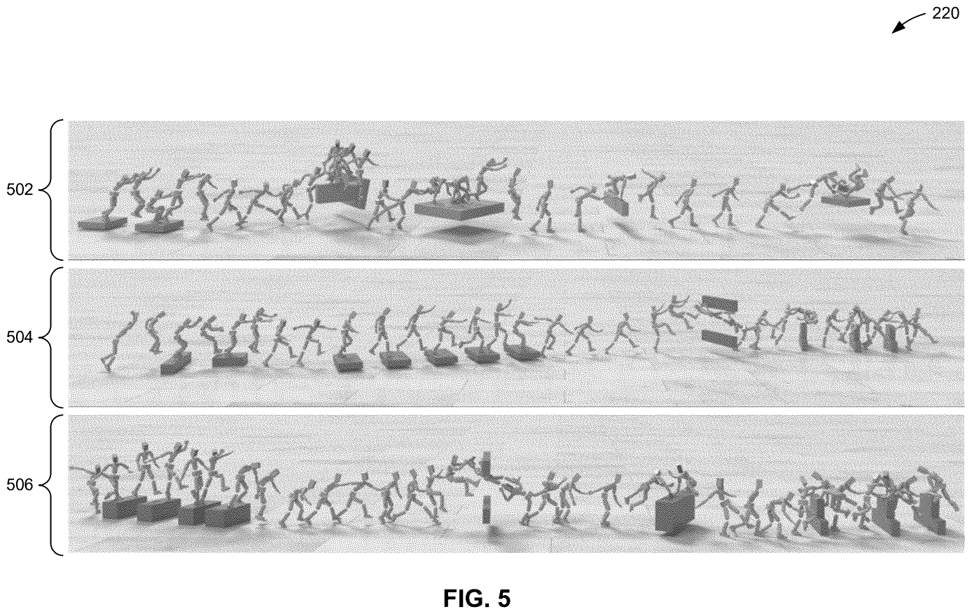

FIG. 5 illustrates a set of example motions 502, 504, and 506 generated by trained policy 220 of FIG. 2, according to at least one embodiment. As shown in FIG. 5, each motion 502, 504, and 506 includes the virtual character interacting with a different sequence of obstacles. Because trained policy 220 has learned both the tracking task and target following task, the virtual character is capable of using diverse skills to clear different types of obstacles and transition smoothly between skills and/or obstacles.

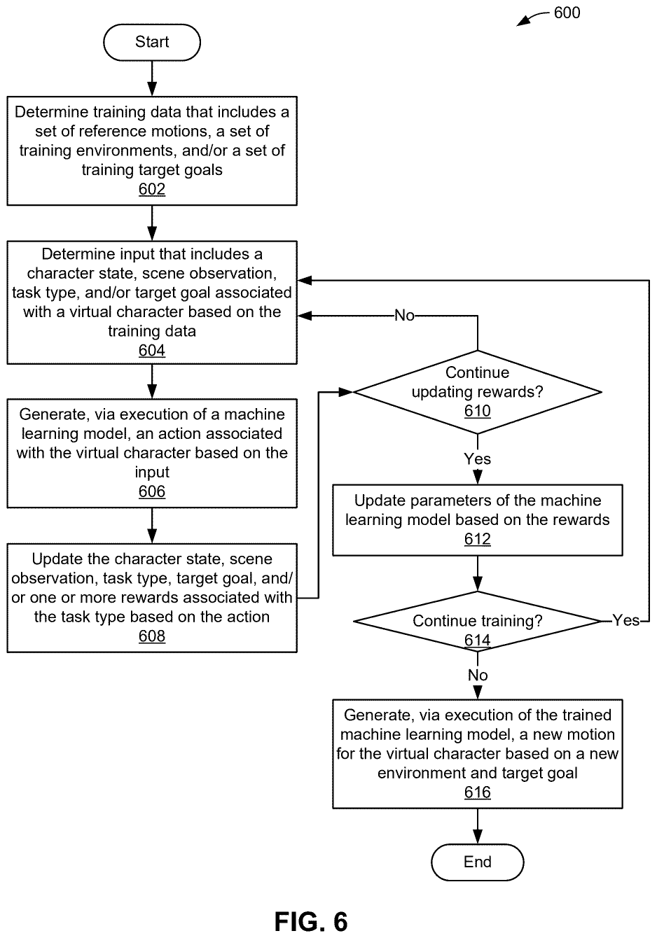

Now referring to FIG. 6, each block of method 600 described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 600 is described, by simulated way of example, with respect to the systems of FIGS. 1-2. However, these methods may additionally or alternatively be executed by any one system, or any combination of systems, including, but not limited to, those described herein. Further, the operations in method 600 may be omitted, repeated, and/or performed in any order without departing from the scope of the present disclosure.

FIG. 6 illustrates a flow diagram of a method 600 for training a machine learning model under a hybrid imitation learning framework for neural motion control, according to at least one embodiment. As shown in FIG. 6, method 600 begins with operation 602, in which training engine 122 determines training data that includes a set of reference motions, a set of training environments, and/or a set of training target goals. For example, training engine 122 may generate the reference motions using a motion capture technique, pose estimation technique, and/or another technique that is applied to “real world” motions. Training engine 122 may use simulation and/or human annotation techniques to generate, for each reference motion, a training environment that includes one or more obstacles related to the reference motion. Training engine 122 may also, or instead, generate additional training environments that include sequences of obstacles associated with the reference motions, randomly placed obstacles, and/or other arrangements of obstacles. Training engine 122 may additionally generate training target goals that include randomly sampled locations, user-specified locations, and/or other locations in some or all training environments.

In operation 604, training engine 122 determines input that includes a character state, scene observation, task type, and/or target goal associated with a virtual character based on the training data. For example, training engine 122 may determine the task type as a tracking task or a target following task (e.g., by sampling the task type, alternating between task types, etc.). When the task type is set to the tracking task, training engine 122 may select a reference motion and training environment from the training data. When the task type is set to the target following task, training engine 122 may select a training environment and training target goal from the training data. Training engine 122 may also initialize the character state and scene observation within the selected training environment.

In operation 606, training engine 122 generates, via execution of a machine learning model, an action associated with the virtual character based on the input. For example, the machine learning model may include one or more MLPs that encode the character state and/or target goal into one or more tokens. The machine learning model may also include a PointNet (or another type of neural network that is capable of processing point data) that encodes the scene observation into a set of tokens. The machine learning model may additionally include a transformer and/or another type of neural network that converts the tokens into parameters of an action distribution. After the action distribution is generated, training engine 122 may sample the action from the action distribution.

In operation 608, training engine 122 updates the character state, scene observation, task type, target goal, and/or one or more rewards associated with the task type based on the action. For example, training engine 122 may cause the virtual character to perform the action within a simulation of the training environment. After the action is performed, training engine 122 may generate a corresponding new character state and scene observation for the next time step in the simulation. Training engine 122 may also match the next time step to a corresponding task type specified in the training data. If the action causes the virtual character to reach an existing target goal, training engine 122 may optionally generate and/or determine a new target goal within the training environment. Training engine 122 may further compute one or more rewards associated with the action based on one or more training objectives associated with the task type and/or output from a discriminator model.

In operation 610, training engine 122 determines whether or not to continue updating the rewards. For example, training engine 122 may determine that the rewards should continue to be updated over an episode in which character states, scene observations, task types, and/or target goals are generated and/or updated within a corresponding training environment based on actions outputted by the machine learning model. While training engine 122 determines that updating of the rewards should continue, training engine 122 repeats operations 604, 606, and 608 to generate additional actions, character states, scene observations, task types, target goals, and/or reward(s) using the machine learning model.

Once training engine 122 determines in operation 610 that updating of the rewards is no longer to continue, training engine 122 performs operation 612, in which training engine 122 updates parameters of the machine learning model based on the rewards. For example, training engine 122 may update the parameters of the machine learning model based on the rewards and expected returns generated by a critic model from the corresponding character states, scene observations, task types, and/or target goals.

In operation 614, training engine 122 determines whether training of the machine learning model is complete. For example, training engine 122 may determine that training is complete when one or more conditions are met. These condition(s) include (but are not limited to) convergence in the parameters of the machine learning model, an increase in the cumulative rewards above one or more thresholds, and/or a certain number of training steps, iterations, episodes, and/or epochs. While training of the machine model is not complete, training engine 122 repeats one or more iterations of operations 602, 604, 606, 608, 610, and 612. Training engine 122 then ends the process of training the machine model once training engine 122 determines in operation 614 that the condition(s) are met.

In operation 616, execution engine 124 generates, via execution of the trained machine learning model, a new motion for the virtual character based on a new environment and target goal. For example, execution engine 124 may generate an initial character state and corresponding scene observation using a default and/or starting position of the virtual character in the new environment. Execution engine 124 may also select a target goal as a location within the new environment. Execution engine 124 may input the character state, scene observation, and target goal into the trained machine learning model and use the trained machine learning model to generate a corresponding action. Execution engine 124 may add the action to the new motion and use the action to generate an updated character state and scene observation for the next time step. Execution engine 124 may repeat the process for a certain number of time steps, until the target goal is reached, and/or another condition is met. After the target goal is reached, execution engine 124 may optionally generate a new target goal at a different location in the environment and continue using the trained machine learning model to generate new actions that advance the virtual character toward the new target goal.

In sum, the disclosed techniques use a hybrid imitation learning framework to train a machine learning model to generate motions for a virtual character in a variety of complex environments. For example, the hybrid imitation learning framework may be used to generate a trained machine learning model that is capable of performing and rapidly transitioning between a variety of motor skills in environments involving different types and/or combinations of obstacles.

The hybrid imitation learning framework involves a multi-task environment that includes a tracking task and a target following task. In the tracking task, the machine learning model is optimized to track a reference motion on a frame-by-frame basis. For example, the tracking task may involve training the machine learning model to perform a variety of motor skills by imitating reference motions recorded from humans. The tracking task may use a motion tracking reward that encourages the machine learning model to minimize the difference between positions, rotations, linear velocities, angular velocities, root heights, and/or other attributes of the virtual character and corresponding ground truth attributes associated with a given reference motion.

In the target following task, the machine learning model is trained to learn natural interactions with an environment while following a target goal. For example, the target following task may involve sampling a target goal location within an environment that includes various objects and/or obstacles with which the virtual character can interact. The machine learning model may be trained using a task objective that includes a reward that increases as the distance between the virtual character and the target goal location reduces. The machine learning may also be trained using a style objective that is computed using predictions from a discriminator model that aims to distinguish between reference motions and motions outputted by the neural motion control model.

After training of the machine learning model is complete, the machine learning model is used to generate motions for the virtual character in new environments. For example, the machine learning model may generate motions that allow the virtual character to interact with various objects and/or obstacles using learned motor skills and/or smoothly transition between motor skills while moving toward a target goal location within a new environment.

One advantage of the disclosed techniques relative to prior approaches is the ability to generate natural and realistic motions for virtual characters in unseen and/or complex environments. Consequently, a machine learning model trained, retrained, or updated using the disclosed techniques may exhibit improved generalizability and ability to sequence and/or compose different motor skills compared with machine learning models trained using conventional motion tracking techniques. Further, the generated motions may be more realistic and/or natural than those generated via machine learning models trained using conventional distribution matching techniques.

### Inference and Training Logic

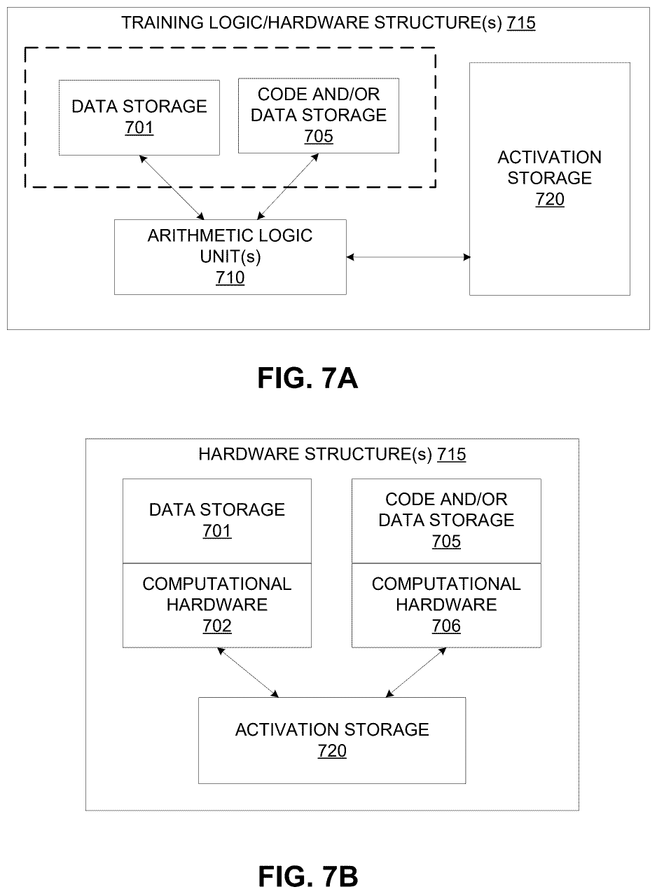

FIG. 7A illustrates inference and/or training logic 715 used to perform inferencing and/or training operations associated with one or more embodiments. Details regarding inference and/or training logic 715 are provided herein in conjunction with at least FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a coprocessor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

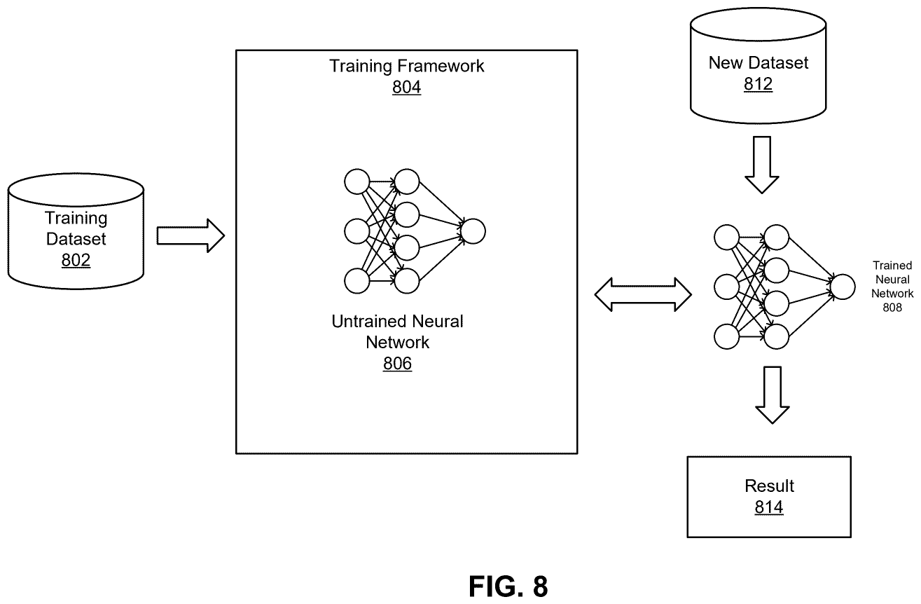

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjust weights to refine an output of untrained neural network 806 using a training objective and adjustment algorithm, such as stochastic gradient descent and/or gradient ascent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

In at least one embodiment, training framework 804 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based neural networks, and/or various other neural network models. In at least one embodiment, Open VINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, Open VINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, OpenVINO provides various software functions to execute a program on one or more devices. In at least one embodiment, Open VINO provides various software functions to execute a program and/or portions of a program on different devices. In at least one embodiment, Open VINO provides various software functions to, for example, run a first portion of code on a CPU and a second portion of code on a GPU and/or FPGA. In at least one embodiment, Open VINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In the present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.
1. In some embodiments, a method comprises generating, via execution of a first machine learning model, a first plurality of actions based on a first plurality of states associated with a virtual character; computing a first set of rewards based on the first plurality of actions and a reference motion for the virtual character; generating, via execution of the first machine learning model, a second plurality of actions based on a second plurality of states associated with the virtual character and a training target goal; computing a second set of rewards based on discriminator output generated by a second machine learning model from the second plurality of actions; and updating one or more parameters of the first machine learning model based on the first set of rewards and the second set of rewards to produce a trained machine learning model.
2. The method of clause 1, further comprising generating, via execution of the trained machine learning model, a third plurality of actions based on a third plurality of states associated with the virtual character and a target goal; and generating a motion for the virtual character based on the third plurality of actions.
3. The method of any of clauses 1-2, wherein the motion comprises one or more interactions between the virtual character and one or more obstacles.
4. The method of any of clauses 1-3, wherein the first set of rewards comprises a weighted combination associated with a plurality of differences between a plurality of attributes included in the first plurality of actions and a plurality of reference attributes included in the reference motion.
5. The method of any of clauses 1-4, wherein the plurality of attributes corresponds to the virtual character and comprises at least one of a joint position, a joint rotation, a joint linear velocity, a joint angular velocity, or a root height.
6. The method of any of clauses 1-5, wherein the second set of rewards is further computed based on one or more distances between the virtual character and the training target goal.
7. The method of any of clauses 1-6, wherein the first plurality of actions is further generated based on a first plurality of scene observations associated with the first plurality of states and the second plurality of actions is further generated based on a second plurality of scene observations associated with the second plurality of states.
8. The method of any of clauses 1-7, wherein each scene observation included in the first plurality of scene observations and the second plurality of scene observations comprises a set of points that is closest to the virtual character.
9. The method of any of clauses 1-8, wherein the training target goal comprises a location to be reached by the virtual character.
10. The method of any of clauses 1-9, wherein the first machine learning model comprises a transformer encoder neural network.
11. In some embodiments, at least one processor comprises processing circuitry to perform operations comprises generating, via execution of a first machine learning model, a first plurality of actions based on a first plurality of states associated with a virtual character; computing a first set of rewards based on the first plurality of actions and a reference motion for the virtual character; generating, via execution of the first machine learning model, a second plurality of actions based on a second plurality of states associated with the virtual character and a training target goal; computing a second set of rewards based on discriminator output generated by a second machine learning model from the second plurality of actions; and updating one or more parameters of the first machine learning model based on the first set of rewards and the second set of rewards to produce a trained machine learning model.
12. The at least one processor of clause 11, wherein the operations further comprise generating, via execution of the trained machine learning model, a third plurality of actions based on a third plurality of states associated with the virtual character and a target goal; and generating a motion for the virtual character based on the third plurality of actions, wherein the motion comprises one or more interactions between the virtual character and one or more obstacles.
13. The at least one processor of any of clauses 11-12, wherein the first set of rewards and the second set of rewards are further computed using a plurality of expected returns generated by a third machine learning model based on a task indicator representing at least one of a tracking task associated with the first set of rewards, or a target following task associated with the second set of rewards.
14. The at least one processor of any of clauses 11-13, wherein the third machine learning model further generates the plurality of expected returns based on at least one of the first plurality of states, the second plurality of states, the training target goal, or a plurality of scene observations associated with the virtual character.
15. The at least one processor of any of clauses 11-14, wherein the third machine learning model comprises a multilayer perceptron.
16. The at least one processor of any of clauses 11-15, wherein the second machine learning model comprises a multilayer perceptron.
17. The at least one processor of any of clauses 11-16, wherein the first machine learning model comprises at least one of one or more multilayer perceptrons, a PointNet neural network, and a transformer encoder neural network.
18. The at least one processor of any of clauses 11-17, wherein the at least one processor is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system implemented using one or more small language models (SLMs); a system implementing one or more vision language models (VLMs); a system implementing one or more multi modal language models; a system for generating synthetic data; a system for performing one or more generative AI operations; a system using or deploying one or more inference microservices; a system that incorporates one or more machine learning models deployed in a service or microservice along with an OS-level virtualization package (e.g., a container); a system incorporating one or more virtual machines (VMs); a system implemented at least partially in a data center; or a system implemented at least partially using cloud computing resources.
19. In some embodiments, a system comprises one or more processors to perform operations comprising generating, via execution of a first machine learning model, a first plurality of actions based on a first plurality of states associated with a virtual character; computing a first set of rewards based on the first plurality of actions and a reference motion for the virtual character; generating, via execution of the first machine learning model, a second plurality of actions based on a second plurality of states associated with the virtual character and a training target goal; computing a second set of rewards based on discriminator output generated by a second machine learning model from the second plurality of actions; and updating one or more parameters of the first machine learning model based on the first set of rewards and the second set of rewards to produce a trained machine learning model.
20. The system of clause 19, wherein the system is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system implemented using one or more small language models (SLMs); a system implementing one or more vision language models (VLMs); a system implementing one or more multi modal language models; a system for generating synthetic data; a system for performing one or more generative AI operations; a system incorporating one or more virtual machines (VMs); a system using or deploying one or more inference microservices; a system that incorporates one or more machine learning models deployed in a service or microservice along with an OS-level virtualization package (e.g., a container); a system implemented at least partially in a data center; or a system implemented at least partially using cloud computing resources.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
generating, via execution of a first machine learning model, a first plurality of actions based on a first plurality of states associated with a virtual character;
computing a first set of rewards based on the first plurality of actions and a reference motion for the virtual character;
generating, via execution of the first machine learning model, a second plurality of actions based on a second plurality of states associated with the virtual character and a training target goal;
computing a second set of rewards based on discriminator output generated by a second machine learning model from the second plurality of actions; and
updating one or more parameters of the first machine learning model based on the first set of rewards and the second set of rewards to produce a trained machine learning model.

2. The method of claim 1, further comprising:
generating, via execution of the trained machine learning model, a third plurality of actions based on a third plurality of states associated with the virtual character and a target goal; and
generating a motion for the virtual character based on the third plurality of actions.

3. The method of claim 2, wherein the motion comprises one or more interactions between the virtual character and one or more obstacles.

4. The method of claim 1, wherein the first set of rewards comprises a weighted combination associated with a plurality of differences between a plurality of attributes included in the first plurality of actions and a plurality of reference attributes included in the reference motion.

5. The method of claim 4, wherein the plurality of attributes corresponds to the virtual character and comprises at least one of a joint position, a joint rotation, a joint linear velocity, a joint angular velocity, or a root height.

6. The method of claim 1, wherein the second set of rewards is further computed based on one or more distances between the virtual character and the training target goal.

7. The method of claim 1, wherein the first plurality of actions is further generated based on a first plurality of scene observations associated with the first plurality of states and the second plurality of actions is further generated based on a second plurality of scene observations associated with the second plurality of states.

8. The method of claim 7, wherein each scene observation included in the first plurality of scene observations and the second plurality of scene observations comprises a set of points that is closest to the virtual character.

9. The method of claim 1, wherein the training target goal comprises a location to be reached by the virtual character.

10. The method of claim 1, wherein the first machine learning model comprises a transformer encoder neural network.

11. At least one processor comprising:
processing circuitry to perform operations comprising:
generating, via execution of a first machine learning model, a first plurality of actions based on a first plurality of states associated with a virtual character;
computing a first set of rewards based on the first plurality of actions and a reference motion for the virtual character;
generating, via execution of the first machine learning model, a second plurality of actions based on a second plurality of states associated with the virtual character and a training target goal;
computing a second set of rewards based on discriminator output generated by a second machine learning model from the second plurality of actions; and
updating one or more parameters of the first machine learning model based on the first set of rewards and the second set of rewards to produce a trained machine learning model.

12. The at least one processor of claim 11, wherein the operations further comprise:
generating, via execution of the trained machine learning model, a third plurality of actions based on a third plurality of states associated with the virtual character and a target goal; and
generating a motion for the virtual character based on the third plurality of actions, wherein the motion comprises one or more interactions between the virtual character and one or more obstacles.

13. The at least one processor of claim 11, wherein the first set of rewards and the second set of rewards are further computed using a plurality of expected returns generated by a third machine learning model based on a task indicator representing at least one of: a tracking task associated with the first set of rewards, or a target following task associated with the second set of rewards.

14. The at least one processor of claim 13, wherein the third machine learning model further generates the plurality of expected returns based on at least one of: the first plurality of states, the second plurality of states, the training target goal, or a plurality of scene observations associated with the virtual character.

15. The at least one processor of claim 13, wherein the third machine learning model comprises a multilayer perceptron.

16. The at least one processor of claim 11, wherein the second machine learning model comprises a multilayer perceptron.

17. The at least one processor of claim 11, wherein the first machine learning model comprises at least one of: one or more multilayer perceptrons, a PointNet neural network, and a transformer encoder neural network.

18. The at least one processor of claim 11, wherein the at least one processor is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system implemented using one or more small language models (SLMs);
a system implementing one or more vision language models (VLMs);
a system implementing one or more multi modal language models;
a system for generating synthetic data;
a system for performing one or more generative AI operations;
a system using or deploying one or more inference microservices;
a system that incorporates one or more machine learning models deployed in a service or microservice along with an OS-level virtualization package (e.g., a container);
a system incorporating one or more virtual machines (VMs);
a system implemented at least partially in a data center; or
a system implemented at least partially using cloud computing resources.

19. A system comprising:
one or more processors to perform operations comprising:
generating, via execution of a first machine learning model, a first plurality of actions based on a first plurality of states associated with a virtual character;
computing a first set of rewards based on the first plurality of actions and a reference motion for the virtual character;
generating, via execution of the first machine learning model, a second plurality of actions based on a second plurality of states associated with the virtual character and a training target goal;
computing a second set of rewards based on discriminator output generated by a second machine learning model from the second plurality of actions; and
updating one or more parameters of the first machine learning model based on the first set of rewards and the second set of rewards to produce a trained machine learning model.

20. The system of claim 19, wherein the system is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system implemented using one or more small language models (SLMs);
a system implementing one or more vision language models (VLMs);
a system implementing one or more multi modal language models;
a system for generating synthetic data;
a system for performing one or more generative AI operations;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.
